(19) United States
(12) Patent Application Publication
(10) Pub. No.: US 2024/0336859 A1
(43) Pub. Date: Oct. 10, 2024

(54) SURFACTANT COMPOSITIONS, EMULSIONS INCLUDING SURFACTANT COMPOSITIONS, AND METHODS OF PREPARING SAME

(71) Applicant: KATAL ENERGY INC., Calgary (CA)

(72) Inventors: Morteza CHEHEL AMIRANI, Calgary (CA); Sip Chen LIEW, Calgary (CA); Timothy Walter Jonathan ROSE, Calgary (CA); Shinji HASEGAWA, Tokyo (JP)

(21) Appl. No.: 18/293,147

(22) PCT Filed: Jul. 29, 2022
(86) PCT No.: PCT/CA2022/051165

§ 371 Date: Jan. 29, 2024

Related U.S. Application Data
(60) Provisional application No. 63/227,862, filed on Jul. 30, 2021.

(51) Int. Cl. C10L 1/222; C10L 10/14

(52) U.S. Cl. CPC C10L 1/2222; C10L 10/14; C10L 2200/0446; C10L 2250/084

(57) ABSTRACT

There is provided a surfactant composition for use in stabilizing oil in water emulsions, such as water in diesel emulsion fuels. Components of said surfactant compositions can include zwitterionic materials, ionic liquids, as well as amide compounds and alcohols. Methods for producing said surfactant compositions are also disclosed.

### FIELD

This relates to surfactant compositions, including surfactant compositions for preparing oil in water emulsions.

### BACKGROUND

Water in diesel emulsion fuels have been proven to have advantages in terms of reduced emissions with minimal impact on fuel economy. However, they are not widely used due to some inherent limitations, such as stability and homogeneity. Traditional emulsion fuels are suffering from short time stability and low thermal stability due, in part, to surfactants being used. In particular, in traditional emulsion fuels, water separates from the emulsion fuel, (typically, in few weeks or 1-2 months) before the fuel can be used in an engine. Long term stability fuels have been claimed in some prior innovations, however, the thermal stability of them is not addressed. In CI (diesel) engines pressurised fuel is conveyed to the injector(s), some of this is injected into the cylinder and a variable proportion, which is used to cool and lubricate the injector(s) is returned to the fuel tank. The temperature of the returned fuel can reach ˜60° C. and if the emulsion fuel is not stable at that temperature, the returned fuel and, hence, the fuel in the tank, becomes milky, indicating partial separation, which negatively affects the engine performance. The milky or creamy appearance is an indication of large water droplet size of greater than 3-4 microns, which can easily be removed by inline water agglomerator filters required in high-precision, high pressure fuel injector systems. In addition to the long term and thermal stability issues, water freezes in the cold weather conditions and is irreversibly separated from the emulsion even if the fuel becomes fully liquid again. Addition of antifreezes slightly lowers the freezing point. However, if the fuel is frozen, water will be separated, and fuel tank or fuel lines in the engine may need to be defrosted and flushed before the engine can be operated reliably.

### SUMMARY

In one aspect, there is provided a surfactant composition comprising:
(a) a first oil-soluble surfactant (“FOSS”) material;
wherein:
   the FOSS material is defined by at least one FOSS compound;
   each one of the at least one FOSS compound, independently, is an ionic liquid or a zwitterion;
   for each one of the at least one FOSS compound that is an ionic liquid, independently, the FOSS compound is of formula (I):

Q-S;
wherein:
   Q is bonded to S via an ionic bond;
   Q is of formula (II):

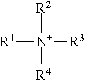

wherein:
   each one of R¹, R², and R³, independently, is hydrogen or a methyl group, with the proviso that at least one of R¹, R², and R³ is hydrogen; and
   R⁴ is an aliphatic group or an aryl group;
and
S is of formula (III):

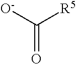

wherein R⁵ is an aliphatic group;
for each one of the at least one FOSS compound that is a zwitterion, independently, the FOSS compound is of formula (IV):

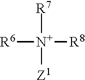

wherein:
   each one of R⁶ and R⁸, independently, is hydrogen;
   R⁷ is an aliphatic group that includes a carbonyl group; and
   Z¹ is a negatively charged carboxylate ion;
(b) a second oil-soluble surfactant (“SOSS”) material;
wherein:
   the SOSS material is defined by at least one SOSS compound;
   each one of the at least one SOSS compound, independently, is an ionic liquid or a zwitterion;
   for each one of the at least one SOSS compound that is an ionic liquid, independently, the SOSS compound is of formula (V):

X—Y;
wherein:
   X is bonded to Y via an ionic bond;
   X is of formula (VI):

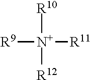

wherein:
   each one of R⁹, R¹⁰, and R¹¹, independently, is hydrogen; and
   R¹² is an aliphatic group;
and
Y is of formula (VII):

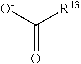

wherein R¹³ is an aliphatic group;
for each one of the at least one SOSS compound that is a zwitterion, independently, the SOSS compound is of formula (VII):

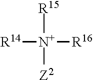

wherein:
   each one of R¹⁴ and R¹⁶, independently, is hydrogen;
   R¹⁵ is an aliphatic group that includes a carbonyl group; and
   Z² is a negatively charged carboxylate ion;
(c) a co-surfactant material;
wherein:
   the co-surfactant material is defined by at least one co-surfactant compound; and
   each one of the at least one co-surfactant compound, independently, is of formula (IX):

R¹⁷—OH
wherein R¹⁷ is an aliphatic group;
   and
(d) a water-soluble surfactant material;
wherein:
   the water-soluble surfactant material is defined by at least one water-soluble surfactant compound;
   each one of the at least one water-soluble surfactant compound, independently, is of formula (X):

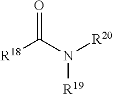

R¹⁸ is hydrogen, an aliphatic group, or an aryl group; and
each one of R¹⁹ and R²⁰, independently, is hydrogen or an alcohol moiety.

In another aspect, there is provided a surfactant composition comprising:
(a) an oil-soluble surfactant material;
wherein:
   the oil-soluble surfactant material is defined by at least one oil-soluble surfactant compound;
   each one of the at least one oil-soluble surfactant compound, independently, is an ionic liquid or a zwitterion;
   for each one of the at least one oil-soluble surfactant compound that is an ionic liquid, independently, the oil-soluble surfactant compound is of formula (I):

Q-S;
wherein:
   Q is bonded to S via an ionic bond;
   Q is of formula (II):

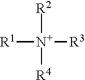

wherein:
   each one of R¹, R², and R³, independently, is hydrogen or a methyl group, with the proviso that at least one of R¹, R², and R³ is hydrogen; and
   R⁴ is an aliphatic group or an aryl group;
and
S is of formula (III):

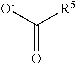

wherein R⁵ is an aliphatic group;
for each one of the at least one oil-soluble surfactant compound that is a zwitterion, independently, the oil-soluble surfactant compound is of formula (IV):

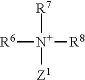

wherein:
   each one of R⁶ and R⁸, independently, is hydrogen;
   R⁷ is an aliphatic group that includes a carbonyl group; and
   Z¹ is a negatively charged carboxylate ion;
(b) a co-surfactant material;
wherein:
   the co-surfactant material is defined by at least one co-surfactant compound; and
   each one of the at least one co-surfactant compound, independently, is of formula (IX):

R¹⁷—OH
wherein R¹⁷ is an aliphatic group;
   and
(c) a water-soluble surfactant material;
wherein:
   the water-soluble surfactant material is defined by at least one water-soluble surfactant compound;
   each one of the at least one water-soluble surfactant compound, independently, is of formula (X):

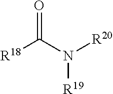

R¹⁸ is hydrogen, an aliphatic group, or an aryl group; and
each one of R¹⁹ and R²⁰, independently, is hydrogen or an alcohol moiety.

In another aspect, there is provided a surfactant composition comprising:
(a) a first oil-soluble surfactant (“FOSS”) material;
wherein:
   the FOSS material is defined by at least one FOSS compound;
   each one of the at least one FOSS compound, independently, is an ionic liquid or a zwitterion;
   for each one of the at least one FOSS compound that is an ionic liquid, independently, the FOSS compound is of formula (I):

Q-S;
wherein:
   Q is bonded to S via an ionic bond;
   Q is of formula (II):

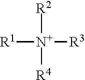

wherein:
   each one of R¹, R², and R³, independently, is hydrogen or a methyl group, with the proviso that at least one of R¹, R², and R³ is hydrogen; and
   R⁴ is an aliphatic group or an aryl group;
and
S is of formula (III):

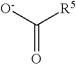

wherein R⁵ is an aliphatic group;
for each one of the at least one FOSS compound that is a zwitterion, independently, the FOSS compound is of formula (IV):

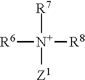

wherein:
   each one of R⁶ and R⁸, independently, is hydrogen;
   R⁷ is an aliphatic group that includes a carbonyl group; and
   Z¹ is a negatively charged carboxylate ion;
(b) a second oil-soluble surfactant (“SOSS”) material;
wherein:
   the SOSS material is defined by at least one SOSS compound;
   each one of the at least one SOSS compound, independently, is an ionic liquid or a zwitterion;
   for each one of the at least one SOSS compound that is an ionic liquid, independently, the SOSS compound is of formula (V):

X—Y;
wherein:
   X is bonded to Y via an ionic bond;
   X is of formula (VI):

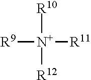

wherein:
   each one of R⁹, R¹⁰, and R¹¹, independently, is hydrogen; and
   R¹² is an aliphatic group;
and
Y is of formula (VII):

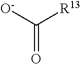

wherein R¹³ is an aliphatic group;
for each one of the at least one SOSS compound that is a zwitterion, independently, the SOSS compound is of formula (VIII):

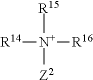

wherein:
   each one of R¹⁴ and R¹⁶, independently, is hydrogen;
   R¹⁵ is an aliphatic group that includes a carbonyl group; and
   Z² is a negatively charged carboxylate ion.

In another aspect, there is provided a method of making a surfactant composition comprising:
admixing at least a precursor-acid and a co-surfactant material to obtain a first intermediate material, such that the first intermediate material includes the precursor acid and the co-surfactant material;
admixing at least the first intermediate material and a SOSS compound-generating precursor amine material, to obtain a second intermediate material;
admixing at least the second intermediate material and a FOSS compound-generating precursor amine material, to obtain a third intermediate material; and
admixing at least the third intermediate material and a water-soluble surfactant material.

### DETAILED DESCRIPTION

There is provided a surfactant composition comprising:
(a) a first oil-soluble surfactant (“FOSS”) material;
   wherein:
      the FOSS material is defined by at least one FOSS compound;
      each one of the at least one FOSS compound, independently, is an ionic liquid or a zwitterion;
      for each one of the at least one FOSS compound that is an ionic liquid, independently, the FOSS compound is of formula (I):

Q-S;
wherein:
   Q is bonded to S via an ionic bond;
   Q is of formula (II):

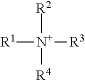

wherein:
each one of R¹, R², and R³, independently, is hydrogen or a methyl group, with the proviso that at least one of R¹, R², and R³ is hydrogen; and
R⁴ is an aliphatic group or an aryl group;
and
S is of formula (III):

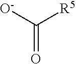

wherein R⁵ is an aliphatic group;
for each one of the at least one FOSS compound that is a zwitterion, independently, the FOSS compound is of formula (IV):

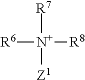

wherein:
   each one of R⁶ and R⁸, independently, is a methyl group;
   R⁷ is an aliphatic group; and
   Z¹ is a negatively charged carboxylate ion;
(b) a second oil-soluble surfactant (“SOSS”) material;
   wherein:
      the SOSS material is defined by at least one SOSS compound;
      each one of the at least one SOSS compound, independently, is an ionic liquid or a zwitterion;
      for each one of the at least one SOSS compound that is an ionic liquid, independently, the SOSS compound is of formula (V):

X—Y;
wherein:
   X is bonded to Y via an ionic bond;
   X is of formula (VI):

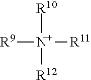

wherein:
each one of R⁹, R¹⁰, and R¹¹, independently, is hydrogen; and
R¹² is an aliphatic group;
and
Y is of formula (VII):

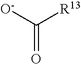

wherein R¹³ is an aliphatic group;
for each one of the at least one SOSS compound that is a zwitterion, independently, the SOSS compound is of formula (VIII):

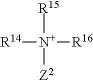

wherein:
   each one of R¹⁴ and R¹⁶, independently, is a methyl group;
   R¹⁵ is an aliphatic group; and
   Z² is a negatively charged carboxylate ion;
(c) a co-surfactant material;
   wherein:
      the co-surfactant material is defined by at least one co-surfactant compound; and
      each one of the at least one co-surfactant compound, independently, is of formula (IX):

R¹⁷—OH
wherein R¹⁷ is an aliphatic group;
   and
(d) a water-soluble surfactant material;
   wherein:
      the water-soluble surfactant material is defined by at least one water-soluble surfactant compound;
      each one of the at least one water-soluble surfactant compound, independently, is of formula (X):

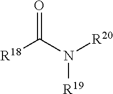

R¹⁸ is hydrogen, an aliphatic group, or an aryl group; and
each one of R¹⁹ and R²⁰, independently, is hydrogen or an alcohol moiety.

In some embodiments, for example, the surfactant composition optionally includes ammonium hydroxide.

### Proportions of Constituent Materials

As described above, the surfactant composition comprises the first oil-soluble surfactant (“FOSS”) material (hereinafter, “A”), the second oil-soluble surfactant (“SOSS”) material (hereinafter, “B”), the co-surfactant material (hereinafter, “C”), and the water-soluble surfactant material (hereinafter, “D”).

In some embodiments, for example, the surfactant composition includes (a) from 59 to 66 weight % of A, based on the total weight of the surfactant composition, (b) from five (5) to 11 weight % of B, based on the total weight of the surfactant composition, (c) from 10 to 25 weight % of C, based on the total weight of the surfactant composition, and (d) from 10 to 14 weight % of D based on the total weight of the surfactant composition.

In some embodiments, for example, A, B, C, and D are present in the surfactant composition such that the ratio of weight of A to the weight of B to the weight of C to the weight of D is W_{A}:W_{B}:W_{C}:W_{D}, wherein W_{A} is from 59 to 66, W_{B} is from five (5) to 11, W_{C} is from 10 to 25, and W_{D} is from 10 to 14. In some of these embodiments, for example, A, B, C, and D are present in the surfactant composition such that the ratio of weight of A to the weight of B to the weight of C to the weight of Dis W_{A}:W_{B}:W_{C}:W_{D}, wherein W_{A} is from 61 to 63, W_{B} is from 5.5 to 6.8, W_{C} is from 15 to 20, and W_{D} is from 11 to 12.

In some embodiments, for example, A and B are present in the surfactant composition such that the ratio of the weight of A to the weight of B is W_{A}:W_{B}, wherein W_{A} is from 59 to 66 and W_{B} is from 5 to 11. In some of these embodiments, for example, A and B are present in the surfactant composition such that the ratio of the weight of A to the weight of B is W_{A}:W_{B}, wherein W_{A} is from 61 to 63 and W_{B} is from 5.5 to 6.8.

In some embodiments, for example, A, B, and C are present in the surfactant composition such that the ratio of the combined weight of A and B to the weight of C is W_{AB}:W_{C}, wherein W_{AB} is from 64 to 77 and W_{C} is from 10 to 25. In some embodiments, for example, A, B, and C are present in the surfactant composition such that the ratio of the combined weight of A and B to the weight of C is W_{AB}:W_{C}, wherein W_{AB} is from 66.5 to 69.8 and W_{C} is from 15 to 20.

In some embodiments, for example, A, B, and D are present in the surfactant composition such that the ratio of the combined weight of A and B to the weight of D is W_{AB}:W_{D}, wherein W_{AB} is from 64 to 77 and W_{D} is from 10 to 14. In some embodiments, for example, A, B, and D are present in the surfactant composition such that the ratio of the combined weight of A and B to the weight of D is W_{AB}:W_{D}, wherein W_{AB} is from 66.5 to 69.8 and W_{D} is from 11 to 12.

### FOSS Compounds

In some embodiments, for example, each one of the at least one FOSS compound is configured to co-operate with liquid hydrocarbon material (e.g. diesel fuel) such that, at a temperature of 25 degrees Celsius and at a pressure of one (1) atmosphere, for each one of the at least one FOSS compound, the FOSS compound is miscible in liquid hydrocarbon material (e.g. diesel fuel). In some embodiments, for example, each one of the at least one FOSS compound, independently, is configured to co-operate with a mixture of liquid hydrocarbon material (e.g. diesel fuel) and water such that, at a temperature of 25 degrees Celsius and at a pressure of one (1) atmosphere, and in the absence of a significant energy input, for each one of the at least one FOSS compound, independently, admixing of an effective amounts of the FOSS compound, liquid hydrocarbon material (e.g. diesel fuel), and water co-operate to produce a water in liquid hydrocarbon material (e.g. diesel fuel) nanoemulsion wherein the size of at least 90% of the water droplets is less than 15 nanometers. In some embodiments, for example, the admixing is effected by agitation at mid to high speed with a blender, having a power to volume ratio from 0.3 kW/L to 0.6 kW/L, and, in this respect, such admixing is exemplary of an admixing effected in the absence of a significant energy input.

### (a) FOSS Compounds of Formula (1)

With respect to each one of the at least one FOSS compound of formula (I), independently, in some embodiments, for example, the counterion Q is defined by a weak acid (for example, the counterion Q has a pKa from 4 to 6) and counterion S is defined by a strong base (pKa is greater than 10).

In those embodiments where R⁴ of the counterion Q is an aliphatic group, in some of these embodiments, for example, R⁴ includes a total number of one (1) to eight (8) carbon atoms, such as, for example, a total number of four (4) to eight (8) carbon atoms. In some embodiments, for example, R⁴ includes a total number of six (6) carbon atoms. In some embodiments, for example, the selection of the total number of carbons of R⁴ determines the effectiveness of the FOSS compound for sufficiently interacting with a sufficient amount of water. Where the total number of carbons is relatively high (e.g. greater than eight (8), the affinity of the hydrophilic head of the FOSS compound for water deteriorates due to weakened interaction with water, and where the total number of carbons is relatively low (e.g. less than four (4)), the hydrophilic head of the FOSS compound is characterized by fewer water adsorption sites.

In those embodiments where R⁴ of the counterion Q is an aliphatic group, in some of these embodiments, for example, R⁴ is linear, branched, or cyclic. In some embodiments, for example, R⁴ is a cyclic aliphatic group. In some embodiments, for example, where R⁴ is a cyclic aliphatic group, by virtue of the cyclic nature of R⁴, greater contact area between R⁴ and water molecules is facilitated, and thereby promoting the stabilization of water droplets in water in oil emulsions (e.g. water in liquid hydrocarbon material (e.g. diesel fuel) emulsions) due to the formation of hydrogen bonds between the polarized cyclic structure of R⁴ and the hydrogen of water molecules.

In some embodiments, for example, R⁴ of the counterion Q is substituted or unsubstituted, and may include one or more heteroatoms. In some embodiments, for example, R⁴ is saturated or unsaturated.

In some embodiments, for example, R⁴ of the counterion Q is cyclohexylammonium ion.

In some embodiments, for example, R⁵ of the counterion S includes a total number of eight (8) to 20 carbon atoms. In some embodiments, for example, R⁵ includes a total number of 16 to 18 carbon atoms. In some embodiments, for example, R⁵ includes a total number of 17 carbon atoms. For each one of the at least one FOSS compound, independently, the degree of solubility of the FOSS compound within liquid hydrocarbon material (e.g. diesel fuel) is dependent on the length of R⁵. In some embodiments, for example, the total number of carbon atoms in the hydrocarbon chain of R⁵ approximates the average number of carbon atoms in the hydrocarbon chains of the liquid hydrocarbon material (e.g. diesel fuel), with which the surfactant composition is admixed, along with water, to obtain an emulsion (e.g. nanoemulsion). In some embodiments, for example, by selecting a FOSS compound whose R⁵ has a hydrocarbon chain having a total number of carbon atoms which approximates the average number of carbon atoms in the hydrocarbon chains of the liquid hydrocarbon material (e.g. diesel fuel), solubility of the FOSS compound within the liquid hydrocarbon material is promoted, which, in turn, promotes the stability of the emulsion (e.g. nanoemulsion).

In some embodiments, for example, R⁵ of the counterion has a varying degree of unsaturation characterized by an iodine value of less than 100. In some embodiments, for example, a lower iodine value prohibits undesired reaction of the FOSS compound with other components of the surfactant composition, such as oxidation of the FOSS compound.

In some embodiments, for example, R⁵ is linear. In this respect, in some embodiments, for example, a high degree of branching causes steric interactions with other components of the surfactant composition and derogates from the stability of the emulsion.

In some embodiments, for example, R⁵ of the counterion S is substituted or unsubstituted, and may include one or more heteroatoms. In some embodiments, for example, R⁵ of the counterion B is saturated or unsaturated.

In some embodiments, for example, the at least one FOSS compound includes fatty acid salts. In some of these embodiments, for example, the acid form of the fatty acid salt has a fatty acid value from 195 mg KOH/g to 210 mg KOH/g.

Exemplary FOSS compounds of formula (I) include fatty acid cyclohexylamine salts, such as, for example, cyclohexylammonium oleate, and cyclohexylammonium stearate.

### (b) FOSS Compounds of Formula (IV)

With respect to the FOSS compounds of formula (IV), the charged functional groups are effective for interacting with water.

With respect to Z¹ of the FOSS compounds of formula (IV) being a negatively charged carboxylate ion, the interaction of the negatively charged carboxylate ion with protonated nitrogen has been demonstrated to be sufficiently strong at different temperature ranges and suitable for use in water in liquid hydrocarbon material (e.g. diesel fuel) emulsions.

In some embodiments, for example, R⁷ of the FOSS compounds of formula (IV) is a saturated or monounsaturated aliphatic group. In those embodiments where R⁷ of the FOSS compounds of formula (IV) is a saturated or monounsaturated aliphatic group, in some of these embodiments, for example, interaction with the liquid hydrocarbon material is promoted (due to the hydrophobic nature of the liquid hydrocarbon material).

In some embodiments, for example, R⁷ of the FOSS compounds of formula (IV) is a saturated aliphatic group with a total number of 8 to 20 carbon atoms, such as, for example, 14 carbon atoms. In some embodiments, for example, the total number of carbons of the hydrocarbon chain of R⁷ approximates the average number of carbon atoms in the hydrocarbon chains of the liquid hydrocarbon material (e.g. diesel fuel), with which the surfactant composition is admixed, along with water, to obtain an emulsion (e.g. a nanoemulsion). In some embodiments, for example, by selecting a FOSS compound whose R⁷ has a hydrocarbon chain having a total number of carbon atoms which approximates the average number of carbon atoms in the hydrocarbon chains of the liquid hydrocarbon material (e.g. diesel fuel), solubility of the FOSS compound within the liquid hydrocarbon material is promoted, which, in turn, promotes the stability of the emulsion (e.g. nanoemulsion).

Exemplary FOSS compounds of formula (IV) include the following:

### (i) (N,N-Dimethylmyristylammonio)acetate

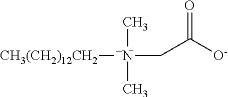

### (ii) (Lauryldimethylammonio)acetate

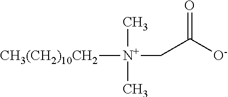

### SOSS Compounds

In some embodiments, for example, for each one of the at least one SOSS compound, independently, at atmospheric pressure, the interfacial elasticity in the emulsion is higher than that compared with the FOSS compound. In this respect, the inclusion of the at least one SOSS compound within the surfactant composition is with effect that the surfactant composition is characterized by a higher interfacial elasticity versus a surfactant composition without the at least one SOSS compound. With a higher interfacial elasticity, the interfacial film between water and diesel becomes more rigid and the surfactant composition becomes resistant to phase change when exposed to higher temperature environments and, therefore, becomes suitable for use in higher temperature applications, such as, for example, diesel engines.

In some embodiments, for example, each one of the at least one SOSS compound, independently, is configured to co-operate with liquid hydrocarbon material (e.g. diesel fuel) such that, at a temperature of 25 degrees Celsius and at a pressure of one (1) atmosphere, for each one of the at least one SOSS compound, independently, SOSS compound is miscible in liquid hydrocarbon material (e.g. diesel fuel).

### (a) SOSS Compounds of Formula (V)

In some embodiments, for example, the counterion X is defined by a weak acid (for example, the counterion X has a pKa of four (4) to six (6)) and counterion Y is defined by a strong base.

In some embodiments, for example, R¹² of the counterion X may be linear or branched.

In some embodiments, for example, R¹² of the counterion X may be substituted or unsubstituted, and may include one or more heteroatoms. In some embodiments, for example, R¹² may be saturated or unsaturated.

In some embodiments, for example, R¹² of the counterion X includes a total number of one (1) to three (3) carbon atoms. In some embodiments, for example, R¹² includes a total number of two (2) carbon atoms.

The total number of carbon atoms of R¹² influences the dipole moment of the SOSS compound and hence the strength on the ionic bond between X and Y in the SOSS compound. The strength of the ionic bond influences the thermal stability of the SOSS compound. The thermal stability increases with the strength of the ionic bond. In addition, the total number of carbon atoms of R¹² affects the interaction of the SOSS compound with FOSS compound, and, in the ideal case, the total number of carbon atoms of R¹² in the SOSS compound is relatively low such that the SOSS compound can interact with the FOSS compound in the interfacial layer. In some embodiments, for example, where the total number of carbon atoms is greater than four (4), the interaction between the FOSS compound and the SOSS compound is not optimized, which renders the surfactant composition ineffective, or, at least, less than optimal, for higher temperature applications.

The total number of carbon atoms of R¹² also influences the size of water droplets within a nanoemulsion obtained in response to admixing of at least the surfactant composition, a liquid hydrocarbon material (e.g. diesel fuel), and water. In such nanoemulsion, the SOSS compound is effective for minimizing coalescence of water droplets during thermal fluctuation events at the interface by maintaining adequate surfactant coverage at the water-oil interface. A shorter chain (linear with a fewer total number of carbon atoms) SOSS compound allows for higher mobility of the SOSS compound (relative to the FOSS compound) to respond to any fingering instability (known as Saffman-Taylor instability) on the water interface at elevated temperature and thus minimizing the frequency of major coalescence to occur.

In some embodiments, for example, R¹² of the counterion X is ethanolamine ion.

In some embodiments, for example, R¹³ of the counterion Y includes a total number of eight (8) to 20 carbon atoms. In some embodiments, for example, R¹³ includes a total number of 16 to 18 carbon atoms. The degree of solubility of the SOSS compound within liquid hydrocarbon material (e.g. diesel fuel) is dependent on the length of R¹³. In some embodiments, for example, the total number of carbon atoms in the hydrocarbon chain of R¹³ approximates the average number of carbon atoms in the hydrocarbon chains of the liquid hydrocarbon material (e.g. diesel fuel), with which the surfactant composition is admixed, along with water, to obtain an emulsion (e.g. nanoemulsion). In some embodiments, for example, by selecting a SOSS compound whose R¹³ has a hydrocarbon chain having a total number of carbon atoms which approximates the average number of carbon atoms in the hydrocarbon chains of the liquid hydrocarbon material (e.g. diesel fuel), solubility of the SOSS compound within the liquid hydrocarbon material is promoted, which, in turn, promotes the stability of the emulsion (e.g. nanoemulsion).

In some embodiments, for example, R¹³ of the counterion has a varying degree of unsaturation characterized by an iodine value of less than 100. In some embodiments, for example, the relatively low iodine value prohibits undesired reactions of the SOSS compound with other components of the surfactant composition, such as oxidation of the SOSS compound.

In some embodiments, for example, R¹³ is linear. In this respect, in some embodiments, for example, a high degree of branching causes steric interactions with other components of the surfactant composition and derogates from the stability of the emulsion.

In some embodiments, for example, R¹³ of the counterion S is substituted or unsubstituted, and may include one or more heteroatoms. In some embodiments, for example, R¹³ of the counterion B is saturated or unsaturated.

In some embodiments, for example, SOSS compounds of formula (I) include fatty acid salts. In some of these embodiments, for example, the acid form of the fatty acid salt has a fatty acid value from 195 mg KOH/g to 210 mg KOH/g.

Exemplary SOSS compounds of formula (V) include salts of fatty acids, such as, for example, fatty acid cyclohexylamine salts with a smaller hydrophilic head group as compared with than of the FOSS compound. In some embodiments, for example the SOSS compounds of formula (V) is ethanolamine oleate.

In some embodiments, for example, where the FOSS compound is cyclohexylammonium oleate, in some of these embodiments, for example, the SOSS compound is ethanolammonium oleate.

### (b) SOSS Compounds of Formula (VIII)

With respect to Z² of the SOSS compounds of formula (VIII) being a negatively charged carboxylate ion, the interaction of the negatively charged carboxylate ion with protonated nitrogen has been demonstrated to be sufficiently strong at different temperature ranges and suitable for water in liquid hydrocarbon material (e.g. diesel fuel) emulsions.

In some embodiments, for example, R¹⁵ of the SOSS compounds of formula (VIII) is a saturated or monounsaturated aliphatic group. In those embodiments where R¹⁵ of the SOSS compounds of formula (VIII) is a saturated or monounsaturated aliphatic group, in some of these embodiments, for example, interaction with the liquid hydrocarbon material is promoted (due to the hydrophobic nature of the liquid hydrocarbon material).

In some embodiments, for example, R¹⁵ of the SOSS compounds of formula (VIII) is a saturated aliphatic group with a total number of eight (8) to 12 carbon atoms, such as, for example, 12 carbon atoms. In some embodiments, for example, the total number of carbons of the hydrocarbon chain of R¹⁵ approximates the average number of carbon atoms in the hydrocarbon chains of the liquid hydrocarbon material (e.g. diesel fuel) with which the surfactant composition is admixed, along with water, to obtain an emulsion (e.g. nanoemulsion). In some embodiments, for example, by selecting a SOSS compound whose R¹⁵ has a hydrocarbon chain having a total number of carbon atoms which approximates the average number of carbon atoms in the hydrocarbon chains of the liquid hydrocarbon material (e.g. diesel fuel), solubility of the SOSS compound within the liquid hydrocarbon material is promoted, which, in turn, promotes the stability of the emulsion (e.g. nanoemulsion).

An exemplary SOSS compound of formula (VIII) is C₁₆H₃₃NO₂, which is represented by the following structural formula:

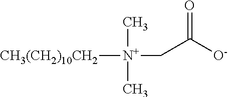

### Co-Surfactant Material

In some embodiments, for example, the co-surfactant material is co-operatively configured with, independently, each one of the at least one FOSS compound such that each one of the at least one FOSS compound is soluble within the co-surfactant material, In some embodiments, for example, the co-surfactant material is co-operatively configured with, independently, each one of the at least one water-soluble surfactant compound such that each one of the at least one water-soluble surfactant compound is soluble within the co-surfactant material. In some embodiments, for example, the co-surfactant material is co-operatively configured with, independently, each one of the at least one FOSS compound such that each one of the at least one FOSS compound is soluble within the co-surfactant compound, and the co-surfactant material is co-operatively configured with, independently, each one of the at least one water-soluble surfactant compound such that each one of the at least one water-soluble surfactant compound is soluble within the co-surfactant material.

In some embodiments, for example, the co-surfactant material is effective for improving the stability of the water in liquid hydrocarbon material (e.g. diesel fuel) emulsion (e.g. nanoemulsion) that is obtained in response to admixing at least the liquid hydrocarbon material, water, and the surfactant composition. In some embodiments, for example, an effective amount of the co-surfactant material is fully miscible in a mixture of at least liquid hydrocarbon material (e.g. diesel fuel) and water. In some of these embodiments, for example, the co-surfactant and liquid hydrocarbon material (e.g. diesel) are co-operatively configured such that the co-surfactant and the liquid hydrocarbon material can be admixed in any proportions without separation into separate phases.

In some embodiments, for example, R¹⁷ of the co-surfactant compound includes a total number of one (1) to five (5) carbon atoms, such as, for example, a total number of one (1) to three (3) carbon atoms, such as, for example, a total number of three (3) carbon atoms. In some embodiments, for example, having a relatively low total number of carbon atoms is conducive to affinity, of the co-surfactant compound, to both the liquid hydrocarbon material (e.g. diesel fuel) phase and the water phase, in those embodiments where an emulsion (such as, for example, a nanoemulsion) is obtained in response to admixing of at least the surfactant composition, the liquid hydrocarbon material (e.g. diesel) and water.

In some embodiments, for example, R¹⁷ of the co-surfactant compound is linear or branched.

Exemplary co-surfactant compounds include propanol, such as, for example, iso-propanol, and butanol, such as, for example, 1-butanol or iso-butanol, and methanol.

### Water-Soluble Surfactant Material

In some embodiments, for example, each one of the at least one water-soluble surfactant compound, independently, is soluble in both water and the liquid hydrocarbon material (e.g. diesel fuel). In some of these embodiments, for example, for each one of the at least one water-soluble surfactant compound, independently, the solubility of the water-soluble surfactant compound in water is greater than the solubility of the water-soluble surfactant compound in the liquid hydrocarbon material (e.g. diesel fuel). It has been shown and reported that mixing of an oil-soluble surfactant material with water-soluble surfactant material often results in more stable water-in-oil emulsions than using only oil-soluble surfactant due to the synergism effect of the surfactant blends. In some embodiments, for example, each one of the at least one water-soluble surfactant compound, independently, has a HLB number of 11 to 14.

In some embodiments, for example, R¹⁸ includes a total number of carbon atoms of eight (8) to 18, such as, for example, a total number of carbon atoms of 10 to 17, such as, for example, a total number of carbon atoms of 11. For each one of the at least one water-soluble surfactant compound, independently, the above-described selection of the total number of carbon atoms represents a balance in solubility of the water-soluble surfactant compound between the liquid hydrocarbon material (e.g. diesel) phase and the water phase.

In some embodiments, for example, for each one of R¹⁹ and R²⁰ independently, the alcohol moiety is:

—C₂H₄OH.

Exemplary water-soluble surfactant compounds include cocamide DEA, lauramide DEA, oleamide DEA, stearamide DEA, linoleamide DEA

### Preparation of Surfactant Composition

A method of preparing the surfactant composition is also provided. The method includes a series of material introduction steps.

In those embodiments where:
(i) each one of the at least one FOSS compound, of the FOSS material, is an ionic liquid of the formula (I); and
(ii) each one of the at least one SOSS compound, of the SOSS material, is an ionic liquid of the formula (V);
in some of these embodiments, for example:
for each one of the at least one FOSS compound, independently, the FOSS compound is obtained via a reactive process, stimulated in response to contacting of a respective FOSS compound-generating precursor acid with a respective FOSS-compound generating precursor amine; and
for each one of the at least one SOSS compound, independently, the SOSS compound is obtained via a reactive process, stimulated in response to contacting of a respective SOSS compound-generating precursor acid with a respective SOSS compound-generating precursor amine.

For each one of the at least one FOSS compound, independently, the respective FOSS compound-generating precursor amine, with which the respective FOSS compound-generating precursor acid is contacted to obtain the FOSS compound, is of formula (XI):

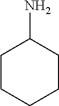

For each one of the at least one FOSS compound, independently, the respective FOSS compound-generating precursor acid, with which the respective FOSS compound-generating precursor amine is contacted to obtain the FOSS compound, is of formula (XII):

H—S
wherein:
   His a hydrogen atom;
   S is above-described; and
   H is bonded to S with an ionic bond.

For each one of the at least one SOSS compound, independently, the respective SOSS compound-generating precursor amine with which the respective SOSS compound-generating precursor acid is contacted to obtain the SOSS compound, is of formula (XIII):

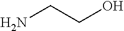

For each one of the at least one SOSS compound, independently, the respective SOSS compound-generating precursor acid, with which the respective SOSS compound-generating precursor amine is contacted to obtain the SOSS compound, is of formula (XIV):

H—Y
wherein:
   H is a hydrogen atom;
   Y is above-described; and
   H is bonded to Y with an ionic bond.

In some embodiments, for example, for each one of the at least one FOSS compound, independently, the respective FOSS compound-generating precursor acid, with which the respective FOSS compound-generating precursor amine is contacted to obtain the FOSS compound, is the same FOSS compound-generating precursor acid (hereinafter, the “common FOSS compound-generating precursor acid”).

In some embodiments, for example, for each one of the at least one SOSS compound, independently, the respective SOSS compound-generating precursor acid, with which the respective SOSS compound-generating precursor amine is contacted to obtain the SOSS compound, is the same SOSS compound-generating precursor acid (hereinafter, the “common SOSS compound-generating precursor acid”).

In some embodiments, for example, for each one of the at least one FOSS compound, independently, the respective FOSS compound-generating precursor acid, with which the respective FOSS compound-generating precursor amine is contacted to obtain the FOSS compound, is the common FOSS compound-generating precursor acid, and for each one of the at least one SOSS compound, independently, the respective SOSS compound-generating precursor acid, with which the respective SOSS compound-generating precursor amine is contacted to obtain the SOSS compound, is the common SOSS compound-generating precursor acid, and the common FOSS compound-generating precursor acid and the common SOSS compound-generating precursor acid are the same precursor acid (hereinafter, the “common precursor acid”).

In some of these embodiments, for example, at least the common precursor acid and the co-surfactant material is admixed within a contacting zone to obtain a first intermediate material. The first intermediate material includes the common precursor acid and the co-surfactant material.

In some embodiments, for example, at least the obtained first intermediate material and a SOSS compound-generating precursor amine material, defined by at least one SOSS compound-generating precursor amine, is admixed to obtain a second intermediate material. The admixing is effected either in the same contacting zone as that within which the admixing of at least the common precursor acid and the co-surfactant material is effected, or in a different contacting zone from that within which the admixing of at least the common precursor acid and the co-surfactant material is effected. The admixing effects contacting of the common precursor acid with the SOSS compound-generating precursor amine material, such that, for each one of the at least one SOSS compound-generating precursor amine, a reactive process is effected, such that at least one reactive process is effected, with effect that the at least one SOSS compound (of the SOSS material) is produced, and such that the second intermediate material is obtained and includes the co-surfactant material, the SOSS material, and unreacted common precursor acid. In this respect, the amounts of common precursor acid and the SOSS compound-generating precursor amine material are co-operatively configured such that the at least one reactive process effects consumption of only a portion of the common precursor acid, with effect that residual common precursor acid remains within the second intermediate material after the admixing with the SOSS compound-generating precursor amine material, for purposes of later reacting with the FOSS compound-generating precursor amine material.

In some embodiments, for example, at least the obtained second intermediate material and the FOSS compound-generating precursor amine material, defined by at least one FOSS compound-generating precursor amine, is then admixed to obtain a third intermediate material. The admixing is effected either in the same contacting zone as that within which the admixing of at least the first intermediate material and the SOSS compound-generating precursor amine material is effected, or in a different contacting zone from that within which the admixing of at least the first intermediate material and the SOSS compound-generating precursor amine material is effected. The admixing effects contacting of the common precursor acid with the FOSS compound-generating precursor amine material such that, for each one of the at least one FOSS compound-generating precursor amine, a reactive process is effected, such that at least one reactive process is effected, with effect that the at least one FOSS compound (of the FOSS material) is produced, and such that the second intermediate material is obtained and includes the co-surfactant material, the FOSS material, and unreacted common precursor acid.

In this respect, in some embodiments, for example, the admixing of the common precursor acid with the SOSS compound-generating precursor amine material is effected prior to the admixing of the common precursor acid with the FOSS compound-generating precursor amine material. In doing so, the SOSS compound-generating precursor amine material does not compete with the FOSS compound-generating precursor amine material for the common precursor acid, thereby providing greater reliability that at least most, if not all, or substantially all, of the SOSS compound-generating precursor amine material is converted to the SOSS material.

Also in this respect, the admixing of at least the common precursor acid and the co-surfactant material is effected prior to the introduction of the FOSS compound-generating precursor amine material (for admixing of the FOSS compound-generating precursor amine material with the common precursor acid). The admixing of at least the common precursor acid and the co-surfactant material effects solvation of the common precursor acid, with effect that, upon admixing with the FOSS compound-generating precursor amine material, the obtained third intermediate material is in the form of a liquid. In some embodiments, for example, unless the common precursor acid is solvated when admixed with the FOSS compound-generating precursor amine material, upon admixing with the FOSS compound-generating precursor amine material, the resultant admixture is in the form of a gel. In such case, in order to introduce other material components into the resultant admixture (e.g, introduction of other material components of the surfactant composition), or introduce other material components into derivatives of the admixture (e.g. introduction of a liquid hydrocarbon material into the surfactant composition which derives from such admixture), for each one of the resultant admixture/derivatives of the resultant admixture (hereinafter “material gel intermediates”), the material gel intermediate would need to be heated in order to facilitate effective introduction of the other material components by admixing.

Also in this respect, the admixing of at least the common precursor acid and the co-surfactant material is effected prior to both of: (i) the introduction of the SOSS compound-generating precursor amine material (for admixing of the SOSS compound-generating precursor amine material with the common precursor acid), and (ii) the introduction of the FOSS compound-generating precursor amine material (for admixing of the FOSS compound-generating precursor amine material with the common precursor acid). In some of these embodiments, for example, in doing so, the viscosity of the common precursor acid is reduced, thereby rendering its dispersion less difficult and less energy consuming during subsequent admixing.

In some embodiments, for example, the admixing of at least the obtained second intermediate material and the FOSS compound-generating precursor amine material is effected in the same contacting zone as that within which the admixing of at least the first intermediate material and the SOSS compound-generating precursor amine material is effected, and the reactive process, effected in response to the admixing of the common precursor acid with the SOSS compound-generating precursor amine material, is exothermic, such that the temperature of the contacting zone, within which the admixing is effected, increases. In this respect, in some of these embodiments, during the admixing of the first intermediate material with the SOSS compound-generating precursor amine material, the temperature within the contacting zone is monitored, and when it is sensed that the temperature within the contacting zone has stabilized (thereby providing an indication that the reactive process, effected in response to the admixing of the common precursor acid with the SOSS compound-generating precursor amine material, is at, or near completion), the FOSS compound-generating precursor amine material is supplied to the contacting zone, such that the admixing of at least the second intermediate material and the FOSS compound-generating precursor amine material is effected. In some embodiments, for example, the sensing of the stabilizing of the temperature within the contacting zone is based upon a sensed temperature decrease (thereby providing an indication that the reactive process has terminated, and heat is no longer being generated and is, rather, being conducted from the contacting zone).

At least the third intermediate material and the water-soluble surfactant material is then admixed, with effect that the surfactant composition is obtained. The admixing is effected either in the same contacting zone as that within which the admixing of at least the second intermediate material and the FOSS compound-generating precursor amine material is effected, or in a different contacting zone from that within which the admixing of at least the second intermediate material and the FOSS compound-generating precursor amine material is effected.

In this respect, in some embodiments, for example, the material introduction of the water-soluble surfactant material, within the surfactant composition, only occurs after both of: (a) the contacting of the common precursor acid with the SOSS compound-generating precursor amine material, and (b) the contacting of the common precursor acid with the FOSS compound-generating precursor amine material, as, otherwise, the presence of the water-soluble surfactant material may interfere with the reactive processes associated with the contacting in (a) and (b).

Also in this respect, in some embodiments, for example, the material introduction of the water-soluble surfactant material, within the surfactant composition, only occurs after all of the other material introduction steps. In some of these embodiments, for example, the water-soluble surfactant material (e.g. cocamide DEA) is relatively viscous, and it is preferable to introduce the water-soluble surfactant material after all of the other material introduction steps so that the material introduction of the water-soluble surfactant material, via admixing, is less energy intensive.

In some embodiments, for example, the admixing of at least the third intermediate material and the water-soluble surfactant material is effected in the same contacting zone as that within which the admixing of at least the obtained second intermediate material and the FOSS compound-generating precursor amine material is effected, and the reactive process, effected in response to the admixing of the common precursor acid with the FOSS compound-generating precursor amine material, is exothermic, such that the temperature of the contacting zone, within which the admixing is effected, increases. In this respect, in some of these embodiments, during the admixing of the first intermediate material with the FOSS compound-generating precursor amine material, the temperature within the contacting zone is monitored, and when it is sensed that the temperature within the contacting zone has stabilized (thereby providing an indication that the reactive process, effected in response to the admixing of the common precursor acid with the FOSS compound-generating precursor amine material, is at or near completion), the water-soluble surfactant material is supplied to the contacting zone, such that the admixing of at least the third intermediate material and the water-soluble surfactant material is effected. In some embodiments, for example, the sensing of the stabilizing of the temperature within the contacting zone is based upon a sensed temperature decrease (thereby providing an indication that the reactive process has terminated, and heat is no longer being generated and is, rather, being conducted from the contacting zone).

### Use of Surfactant Composition

There is also provided a liquid hydrocarbon material-comprising composition which comprises a liquid hydrocarbon material (hereinafter “LHM”), water (hereinafter “WAT”), and any one of the above-described embodiments of the surfactant composition (hereinafter “SUR”). The liquid hydrocarbon material is defined by at least one hydrocarbon compound.

In some embodiments, for example, the liquid hydrocarbon material-comprising composition is an admixture of at least a liquid hydrocarbon material, water, and any one of the above-described embodiments of the surfactant composition.

In some embodiments, for example, the liquid hydrocarbon material-comprising composition is an emulsion, such as, for example, a nanoemulsion.

In some embodiments, for example, the liquid hydrocarbon material is a fuel, such as, for example, a diesel fuel.

In some embodiments, for example, LHM, WAT, and SUR are present in the liquid hydrocarbon material-comprising composition such that the ratio of weight of LHM to the weight of WAT to the weight of SUR is W_{LHM}:W_{WAT}:W_{SUR}, wherein W_{LHM} is from 75 to 85, W_{WAT} is from ten (10) to 15, W_{SUR} is from five (5) to ten (10).

Further embodiments will now be described in further detail with reference to the following non-limitative examples.

The diesel fuel, used in the examples, was a ultra low sulfur diesel purchased from a gas station. Water, used in the examples, was reverse osmosis (RO) water. The mixer, used to admix material used in the examples, was a vertical compact table mixer (Cole-Parmer model) with the maximum speed of 2500 rpm.

### Example 1

### Preparation of Surfactant Composition:

49 grams of oleic acid was combined with 20 grams of isopropanol and mixed at 400 rpm for one (1) min. 18 gr of cyclohexylamine was then added to the mixture and mixed at 600 rpm for five (5) minutes. The temperature of the mixture increased to ˜ 60° C. Once the temperature of the mixture began to decrease, one (1) gram of monoethanolamine was then added to the mixture and mixed for one (1) min at 400 rpm. 12 grams of Cocamide DEA was then added to the mixture and mixed at 400 rpm for five (5) minutes. The surfactant composition, in the form of a homogeneous yellowish liquid, was finally obtained and used in the emulsion preparation step.

### Preparation of Emulsion:

12.5 grams of the surfactant composition was mixed with 140 grams of diesel fuel in a beaker for 30 seconds. 20 grams of RO water was added to beaker and mixed for two (2) minutes at 1000 rpm. A clear emulsion was then obtained. The size of water droplets was determined to be ˜14 nanometers. The clear emulsion was stable and remained clear for more than six (6) months.

### Example 2

### Preparation of Surfactant Composition:

49 grams of oleic acid was combined with 20 grams of isopropanol and mixed at 400 rpm for one (1) minute. 18 grams of cyclohexylamine was then added to the mixture and mixed at 600 rpm for five (5) minutes. The temperature of mixture increased to ˜ 60° C. Once the temperature of the mixture began to decrease, one (1) gram of monoethanolamine was then added to the mixture and mixed for one (1) minute at 400 rpm. 12 grams of Cocamide DEA was then added to the mixture and mixed at 400 rpm for five (5) minutes. The surfactant composition, in the form of a homogenous yellowish liquid, was finally obtained and used in the emulsion preparation step.

### Emulsion Preparation:

8.9 grams of the surfactant composition was mixed with 143 grams of diesel fuel in a beaker for 30 seconds. 20 grams of RO water was added to beaker and mixed for two (2) minutes at 1000 rpm. A clear emulsion was then obtained. The size of water droplets was determined to be ˜16 nanometers. The clear emulsion was stable and remained clear for more than four (4) months.

### Example 3

### Preparation of Surfactant Composition:

26 grams of oleic acid was combined with 26 grams of tallow fatty acid and 15 grams of methanol and mixed at 400 rpm for one (1) minute. 19 grams of cyclohexylamine was then added to the mixture and mixed at 600 rpm for five (5) minutes. The temperature of mixture increased to ˜60° C. Once the temperature of the mixture began to decrease, one (1) gram of monoethanolamine was then added to the mixture and mixed for one (1) minute at 400 rpm. 13 grams of Cocamide DEA was then added to the mixture and mixed at 400 rpm for 5 minutes. The surfactant composition, in the form of a homogenous yellowish liquid, was finally obtained and used in the emulsion preparation step.

### Emulsion Preparation:

12.5 grams of the surfactant composition was mixed with 140 grams of diesel fuel in a beaker for 30 seconds. 20 grams of RO water was added to beaker and mixed for two (2) minutes at 1000 rpm. A clear emulsion was then obtained. The clear emulsion was stable and remained clear for more than four (4) months.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A surfactant composition comprising:
(a) a first oil-soluble surfactant (“FOSS”) material;
wherein:
the FOSS material is defined by at least one FOSS compound;
each one of the at least one FOSS compound, independently, is an ionic liquid or a zwitterion;
for each one of the at least one FOSS compound that is an ionic liquid, independently, the FOSS compound is of formula (I):
Q-S;
wherein:
Q is bonded to S via an ionic bond;
Q is of formula (II): 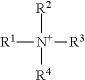
wherein:
each one of R¹, R², and R³, independently, is hydrogen or a methyl group, with the proviso that at least one of R¹, R², and R³ is hydrogen; and
R⁴ is an aliphatic group or an aryl group;
and
S is of formula (III): 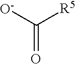
wherein R⁵ is an aliphatic group;
for each one of the at least one FOSS compound that is a zwitterion, independently, the FOSS compound is of formula (IV): 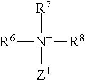
wherein:
each one of R⁶ and R⁸, independently, is hydrogen;
R⁷ is an aliphatic group that includes a carbonyl group; and
Z¹ is a negatively charged carboxylate ion;
(b) a second oil-soluble surfactant (“SOSS”) material;
wherein:
the SOSS material is defined by at least one SOSS compound;
each one of the at least one SOSS compound, independently, is an ionic liquid or a zwitterion;
for each one of the at least one SOSS compound that is an ionic liquid, independently, the SOSS compound is of formula (V):
X—Y;
wherein:
X is bonded to Y via an ionic bond;
X is of formula (VI): 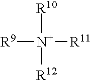
wherein:
each one of R⁹, R¹⁰, and R¹¹, independently, is hydrogen; and
R¹² is an aliphatic group;
and
Y is of formula (VII): 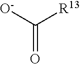
wherein R¹³ is an aliphatic group;
for each one of the at least one SOSS compound that is a zwitterion, independently, the SOSS compound is of formula (VIII): 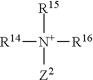
wherein:
each one of R¹⁴ and R¹⁶, independently, is hydrogen;
R¹⁵ is an aliphatic group that includes a carbonyl group; and
Z² is a negatively charged carboxylate ion;
(c) a co-surfactant material;
wherein:
the co-surfactant material is defined by at least one co-surfactant compound; and
each one of the at least one co-surfactant compound, independently, is of formula (IX):
R¹⁷—OH
wherein R¹⁷ is an aliphatic group;
and
(d) a water-soluble surfactant material;
wherein:
the water-soluble surfactant material is defined by at least one water-soluble surfactant compound;
each one of the at least one water-soluble surfactant compound, independently, is of formula (X): 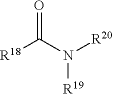
R¹⁸ is hydrogen, an aliphatic group, or an aryl group; and
each one of R¹⁹ and R²⁰, independently, is hydrogen or an alcohol moiety.

2. The surfactant composition as claimed in claim 1
wherein:
the surfactant composition includes (a) from 59 to 66 weight % of the FOSS material, based on the total weight of the surfactant composition, (b) from five (5) to 11 weight % of the SOSS material, based on the total weight of the surfactant composition, (c) from 10 to 25 weight % of the co-surfactant material, based on the total weight of the surfactant composition, and (d) from 10 to 14 weight % of the water-soluble surfactant material, based on the total weight of the surfactant composition.

3. The surfactant composition as claimed in claim 1 or 2;
wherein:
the FOSS material (hereinafter, “A”), the SOSS material (hereinafter, “B”), the co-surfactant material (hereinafter, “C”), and the water-soluble surfactant material (hereinafter, “D”) are present in the surfactant composition such that the ratio of weight of A to the weight of B to the weight of C to the weight of D is W_{A}:W_{B}:W_{C}:W_{D}, wherein W_{A} is from 59 to 66, W_{B} is from five (5) to 11, W_{C} is from 10 to 25, and W_{D} is from 10 to 14.

4. The surfactant composition as claimed in any one of claim 1;
wherein:
each one of the at least one FOSS compound, independently, is an ionic liquid; and
each one of the at least one FOSS compound, independently, is an ionic liquid.

5. A surfactant composition comprising:
(a) an oil-soluble surfactant material;
wherein:
the oil-soluble surfactant material is defined by at least one oil-soluble surfactant compound;
each one of the at least one oil-soluble surfactant compound, independently, is an ionic liquid or a zwitterion;
for each one of the at least one oil-soluble surfactant compound that is an ionic liquid, independently, the oil-soluble surfactant compound is of formula (I):
Q-S;
wherein:
Q is bonded to S via an ionic bond;
Q is of formula (II): 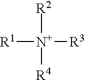
wherein:
each one of R¹, R², and R³, independently, is hydrogen or a methyl group, with the proviso that at least one of R¹, R², and R³ is hydrogen; and
R⁴ is an aliphatic group or an aryl group;
and
S is of formula (III): 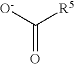
wherein R⁵ is an aliphatic group;
for each one of the at least one oil-soluble surfactant compound that is a zwitterion, independently, the oil-soluble surfactant compound is of formula (IV): 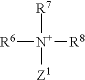
wherein:
each one of R⁶ and R⁸, independently, is hydrogen;
R⁷ is an aliphatic group that includes a carbonyl group; and
Z¹ is a negatively charged carboxylate ion;
(b) a co-surfactant material;
wherein:
the co-surfactant material is defined by at least one co-surfactant compound; and
each one of the at least one co-surfactant compound, independently, is of formula (IX):
R¹⁷—OH
wherein R¹⁷ is an aliphatic group;
and
(c) a water-soluble surfactant material;
wherein:
the water-soluble surfactant material is defined by at least one water-soluble surfactant compound;
each one of the at least one water-soluble surfactant compound, independently, is of formula (X): 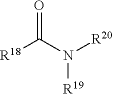
R¹⁸ is hydrogen, an aliphatic group, or an aryl group; and
each one of R¹⁹ and R²⁰, independently, is hydrogen or an alcohol moiety.

6. A surfactant composition comprising:
(a) a first oil-soluble surfactant (“FOSS”) material;
wherein:
the FOSS material is defined by at least one FOSS compound;
each one of the at least one FOSS compound, independently, is an ionic liquid or a zwitterion;
for each one of the at least one FOSS compound that is an ionic liquid, independently, the FOSS compound is of formula (I):
Q-S;
wherein:
Q is bonded to S via an ionic bond;
Q is of formula (II): 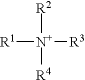
wherein:
each one of R¹, R², and R³, independently, is hydrogen or a methyl group, with the proviso that at least one of R¹, R², and R³ is hydrogen; and
R⁴ is an aliphatic group or an aryl group;
and
S is of formula (III): 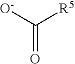
wherein R⁵ is an aliphatic group;
for each one of the at least one FOSS compound that is a zwitterion, independently, the FOSS compound is of formula (IV): 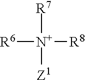
wherein:
each one of R⁶ and R⁸, independently, is hydrogen;
R⁷ is an aliphatic group that includes a carbonyl group; and
Z¹ is a negatively charged carboxylate ion;
(b) a second oil-soluble surfactant (“SOSS”) material;
wherein:
the SOSS material is defined by at least one SOSS compound;
each one of the at least one SOSS compound, independently, is an ionic liquid or a zwitterion;
for each one of the at least one SOSS compound that is an ionic liquid, independently, the SOSS compound is of formula (V):
X—Y;
wherein:
X is bonded to Y via an ionic bond;
X is of formula (VI): 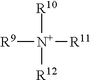
wherein:
each one of R⁹, R¹⁰, and R¹¹, independently, is hydrogen; and
R¹² is an aliphatic group;
and
Y is of formula (VII): 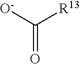
wherein R¹³ is an aliphatic group;
for each one of the at least one SOSS compound that is a zwitterion, independently, the SOSS compound is of formula (VIII): 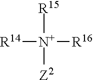
wherein:
each one of R¹⁴ and R¹⁶, independently, is hydrogen;
R¹⁵ is an aliphatic group that includes a carbonyl group; and
Z² is a negatively charged carboxylate ion.

7. The surfactant composition as claimed in claim 6;
wherein:
the FOSS material and the SOSS material are present in the surfactant composition such that the ratio of the weight of the FOSS material to the weight of the SOSS material is W_{A}:W_{A}, wherein W_{A} is from 59 to 66 and W_{B} is from 5 to 11.

8. A liquid hydrocarbon material-comprising composition comprising a liquid hydrocarbon material, water, and the surfactant composition as claimed in claim 1.

9. The liquid hydrocarbon material-comprising composition as claimed in claim 8;
wherein:
the liquid hydrocarbon material is a fuel.

10. The liquid hydrocarbon material-comprising composition as claimed in claim 9;
wherein:
the fuel is diesel fuel.

11. The liquid hydrocarbon material-comprising composition as claimed in claim 8;
wherein:
the liquid hydrocarbon material (hereinafter “LHM”), water (hereinafter “WAT”), and the surfactant composition are present in the liquid hydrocarbon material-based composition such that the ratio of weight of LHM to the weight of WAT to the weight of SUR is W_{LHM}:W_{WAT}:W_{SUR}, wherein W_{LHM} is from 75 to 85, W_{WAT} is from ten (10) to 15, W_{SUR} is from five (5) to ten (10).

12. A method of making a surfactant composition comprising:
admixing at least a precursor-acid and a co-surfactant material to obtain a first intermediate material, such that the first intermediate material includes the precursor acid and the co-surfactant material;
admixing at least the first intermediate material and a SOSS compound-generating precursor amine material, to obtain a second intermediate material;
admixing at least the second intermediate material and a FOSS compound-generating precursor amine material, to obtain a third intermediate material; and
admixing at least the third intermediate material and a water-soluble surfactant material.
